(19) United States
(12) Patent Application Publication
(10) Pub. No.: US 2026/0309248 A1
(43) Pub. Date: Oct. 8, 2026

(54) FAUCET WITH A GLASS RINSER

(71) Applicant: Xiamen Forbetter Sanitary Ware Co., Ltd., Fujian (CN)

(72) Inventors: Xiliang Yan, Fujian (CN); Junhong Xu, Fujian (CN); Mouyong Lin, Fujian (CN)

(21) Appl. No.: 19/463,065

(22) Filed: Jan. 28, 2026

(30) Foreign Application Priority Data
Mar. 14, 2025 (CN) 202520445378.6

(51) Int. Cl. F16K 29/00; A47L 15/00; E03C 1/04; F16K 1/32; F16K 11/00

(52) U.S. Cl. CPC F16K 29/00; A47L 15/0065; E03C 1/04; F16K 1/32; F16K 19/006

(57) ABSTRACT

A faucet with a glass rinser that avoids interference of the glass rinser with the faucet and prevents inadvertent actuation of the glass rinser. The faucet also includes a faucet body, a faucet base, and a valve core assembly. A circumference of the faucet base is at least partially provided with first teeth. The glass rinser is rotatably mounted on one side of the faucet, with the faucet base being an axis of rotation. A water passage in communication with the faucet base and a mounting hole in communication with the water passage are constructed in the glass rinser. The valve core assembly is mounted in the mounting hole, and one end of the valve core assembly exposed from the mounting hole has second teeth that mesh with the first teeth.

### TECHNICAL FIELD

The present invention relates to the technical field of faucets, and more particularly to a faucet with a glass rinser.

### BACKGROUND OF THE INVENTION

A glass rinser is a device used for cleaning glasses. It comes in various types and designs, but usually it rinses a glass by using high-pressure water jets ejecting towards multiple directions into the glass by pressing the glass against the glass rinser. The operation of such glass rinser is very simple and does not require tools such as brushes, so that the cleaning process is efficient and convenient.

In a conventional kitchen sink, user’s equipment costs are high because the glass rinser and the faucet are independent from each other. To address this problem, CN216975870U discloses "A Water Diverting and Outlet Device," which, in its specific embodiment, integrates a glass rinser with a faucet to create a multifunctional faucet with a glass rinser, thereby reducing equipment costs. However, since the glass rinser is typically located at the front of the faucet (facing the user), the user may inadvertently actuate the glass rinser during use of the faucet, causing high-pressure water to eject out and thus wet the user, resulting in poor user’s experience.

### BRIEF SUMMARY OF THE INVENTION

It is an object of the present invention to provide a faucet with a glass rinser that solves the problems existing in the prior art. The present invention allows the glass rinser to be rotated to avoid interference with the faucet and to simultaneously shut off water supply to the glass rinser, thereby preventing inadvertent actuation when the glass rinser is not in use.

To attain the above object, the present invention provides the following technical solutions:

A faucet, comprising a faucet body, a glass rinser, a faucet base, and a valve core assembly; the faucet base is disposed inside the faucet body, and a circumferential surface of the faucet base is at least partially provided with a plurality of first teeth; the glass rinser is disposed on one side of the faucet body and is rotatable about the faucet base with the faucet base being an axis of rotation; the glass rinser is provided with a water passage therein; the faucet base supplies water to the water passage; a mounting hole in communication with the water passage is provided on the glass rinser at a position between two ends of the glass rinser; the valve core assembly is rotatably mounted within the mounting hole; the valve core assembly is sealed against the mounting hole always remains sealed against the mounting hole even when the valve core assembly rotates; an end of the valve core assembly exposed from the mounting hole is provided with a plurality of second teeth at least partially on a circumferential surface thereof; the plurality of second teeth mesh with the plurality of first teeth.

Either the plurality of first teeth or the plurality of second teeth, or both the plurality of first teeth and the plurality of second teeth are distributed partially around a respective circumferential surface of the faucet valve body and/or a respective circumferential surface of the valve core assembly.

Alternatively, the plurality of first teeth extend around the circumferential surface of the faucet base by half a length of the circumferential surface of the faucet base and thus being semi-circular around the circumferential surface of the faucet base; the plurality of second teeth are completely annular around the circumferential surface of the valve core assembly.

The valve core assembly comprises a rotatable shaft, a biasing spring, and two sealing balls; a circumferential surface of one end of the rotatable shaft is at least partially provided with the plurality of second teeth, and a portion of the rotatable shaft above said one end of the rotatable shaft provided with the plurality of second teeth is sealed against the mounting hole and remains sealed against the mounting hole even when the rotatable shaft rotates; the rotatable shaft is also provided with a cross-shaped hole that penetrates through a circumferential surface of the rotatable shaft; the biasing spring is disposed inside the cross-shaped hole, and two ends of the biasing spring are disposed with the two sealing balls respectively.

Alternatively, the valve core assembly comprises a rotatable shaft and a U-shaped cup seal; a circumferential surface of one end of the rotatable shaft is provided with the plurality of second teeth, and a portion of the rotatable shaft above said one end of the rotatable shaft provided with the plurality of second teeth is sealed against the mounting hole and remains sealed against the mounting hole even when the rotatable shaft rotates; the U-shaped cup seal is installed on the circumferential surface of the rotatable shaft; when the rotatable shaft rotates, the U-shaped cup seal opens or closes the communication hole between the water passage and the mounting hole.

The present invention also comprises a water distribution faucet disposed inside the faucet body and connected with the faucet base; the faucet base is provided with a first water inlet path, a second water inlet path, a first water outlet path, and a second water outlet path, all of which being in communication with the water distribution faucet at a surface of the faucet base connecting with the water distribution faucet; input ends of the first water inlet path and the second water inlet path are connected to a cold water pipe and a hot water pipe respectively; output ends of the first water outlet path and the second water outlet path are connected to a water outlet end of the faucet and the glass rinser respectively; a surface of the water distribution faucet connecting with the faucet base has a first water inlet opening, a second water inlet opening, a first water outlet opening, and a second water outlet opening; the first water inlet opening and the second water inlet opening are connected to and in communication with output ends of the first water inlet path and the second water inlet path respectively; the first water outlet opening and the second water outlet opening are connected to and in communication with input ends of the first water outlet path and the second water outlet path respectively.

Preferably, one side of the faucet base is provided with a third water outlet which is the output end of the second water outlet path; an input end of the glass rinser is in communication with the third water outlet.

Preferably, the circumferential surface of the faucet base is also recessed to form a water channel; the third water outlet is disposed in the water channel; the input end of the glass rinser is provided with an annular sealing part; an inner wall of the annular sealing part is in communication with the mounting hole, and the annular sealing part is mounted around the circumferential surface of the faucet base, covering the water channel.

The glass rinser comprises a support platform disposed on said one side of the faucet body, a water passage body disposed within the support platform, a piston rod and a piston spring disposed within the water passage body, a button connected to the piston rod, a nozzle, and an impeller gear; the water passage body is provided with an outlet chamber, an annular channel, and an inlet channel, which are sequentially connected to form the water passage; a circumferential surface of the outlet chamber is provided with at least one inclined water hole; the annular channel is arranged around the circumferential surface of the outlet chamber and communicates with the outlet chamber through said at least one inclined water hole; two ends of the inlet channel are connected to the annular channel and the faucet base respectively; the piston rod, under resilient force of the piston spring, blocks communication between an input end and an output end of the inlet channel; the button is movably fitted on an upper surface of the support platform; the impeller gear is rotatably fitted in the outlet chamber and is positioned facing to said at least one inclined water hole; an outer end of the nozzle is exposed from the upper surface of the support platform, and an inner end of the nozzle is inserted into the passage body and rotatably connected with the impeller gear so that rotation of the impeller gear drives the nozzle to rotate synchronously; a lower portion of the nozzle is sealed against the passage body and remains sealed against the passage body even when the nozzle rotates.

Preferably, a circumferential surface of the impeller gear is provided with a first gear, and the inner end of the nozzle is provided with a second gear that meshes with the first gear; a diameter of the first gear is smaller than a diameter of a blade portion of the impeller gear; a transmission ratio between the first gear and the second gear is at least 1:5.

Preferably, the outer end of the nozzle is provided with an elongated water outlet which is a flat and narrow slit.

Preferably, the water passage body comprises an upper cover, a base, a water passage member, and a connecting member independently constructed with respect to one another; the base, the water passage member, and the connecting member are sequentially sealed, connected, and in communication with one another; the base is provided with a groove; an inner bottom side of the base is raised with a terrace; a periphery of the terrace is provided with an annular groove adjacent to an inner side wall of the groove; the upper cover is sealed and fitted on the inner side wall of the groove, such that the outlet chamber is formed between the upper cover and the terrace, and the annular channel is formed between the upper cover and the annular groove; said at least one inclined water hole is provided on a circumferential surface of the upper cover; communication channels of the water passage member and the connecting member together define said inlet channel; the piston rod is installed in the water passage member.

Preferably, a bottom surface of the support platform is recessed to form a mounting groove; the water passage body is installed in the mounting groove; an opening of the mounting groove is fitted with a bottom cover to conceal the water passage body; the bottom cover is connected to the water passage body by buckling.

Preferably, the glass rinser also comprises a retaining plate; an installation hole is provided on the water passage body vertically passing through the water passage body; the installation hole penetrates through the water passage body; the piston rod is movably mounted within the installation hole; the piston rod is sealed and always remains sealed against the installation hole even when the piston rod moves; an upper end of the piston rod passes through the installation hole and connects with the button; the retaining plate is disposed at a bottom end of the installation hole and seals the bottom end of the installation hole; two sides of the retaining plate are removably connected to the mounting groove.

Preferably, the glass rinser also comprises a drip tray and a rotating base; the rotating base is fixed to an upper surface of the water passage body, and is provided with a shaft tube through which the nozzle passes through; the button is movably fitted with and positioned above the rotating base; the piston rod is disposed below one end of the button, and a reset spring is disposed between another end of the button and the rotating base; the shaft tube passes through the button; the drip tray is rotatably fitted around the shaft tube; the nozzle extends upward to form a column that passes through the shaft tube.

Preferably, an elastic diaphragm is disposed between the rotating base and the support platform; a periphery of the elastic diaphragm is clamped by the support platform and the rotating base; the elastic diaphragm also covers an upper surface of the button.

According to the above technical solutions, the present invention has the following technical effects:

The glass rinser of the present invention can rotate about the faucet base with the faucet base being an axis of rotation, thereby allowing the glass rinser to rotate left and right to avoid interference with the faucet body. When the glass rinser is rotated to a position substantially parallel to an edge of the sink, it is less likely to be inadvertently actuated. Furthermore, mutually meshed first teeth and second teeth enable a linkage movement with the valve core assembly inside the glass rinser, such that when the glass rinser is rotated, the valve core assembly is also driven to control connection and disconnection between the two ends of the water passage. When the valve core assembly is in an open state, the faucet base can supply water to the glass rinser; when the valve core assembly is in a closed state, the faucet base cannot supply water to the glass rinser. User can enable and disable water inlet into the glass rinser by rotating the glass rinser left and right. In the closed state of the valve core assembly, the user is prevented from being wet by high-pressure water due to inadvertently actuation of a button of the glass rinser.

### BRIEF DESCRIPTION OF THE DRAWINGS

FIG. 1 is a perspective view of a first embodiment of the present invention.

FIG. 2 is a schematic view illustrating rotation of the glass rinse according to the first embodiment of the present invention.

FIG. 3 is a schematic view illustrating rotation of the drip tray according to the first embodiment of the present invention.

FIG. 4 is an exploded view of the first embodiment of the present invention.

FIG. 5 is a perspective view showing assembly between the faucet base and the water distribution valve according to the first embodiment of the present invention.

FIG. 6 is a first partial sectional view of the faucet base according to the first embodiment of the present invention.

FIG. 7 is a second partial sectional view of the faucet base according to the first embodiment of the present invention.

FIG. 8 is a schematic view showing water communication between the faucet base and the glass rinser according to the first embodiment of the present invention.

FIG. 9 is a schematic view showing water communication between the faucet base and an water outlet end of the faucet according to the first embodiment of the present invention.

FIG. 10 is an exploded view of the glass rinser of the first embodiment of the present invention.

FIG. 11 is a sectional view of a rotatable shaft according to the first embodiment of the present invention.

FIG. 12 is a cross-sectional view of the glass rinser of the first embodiment of the present invention in an open state.

FIG. 13 is a cross-sectional view of the glass rinser of the first embodiment of the present invention in a closed state.

FIG. 14 is a first perspective view of a partial structure of the first embodiment of the present invention.

FIG. 15 is a second perspective view of the partial structure shown in FIG. 13.

FIG. 16 is a perspective view of the upper cover of the first embodiment of the present invention.

FIG. 17 is a perspective view of the base of the first embodiment of the present invention.

FIG. 18 is a perspective view of the connecting member of the first embodiment of the present invention.

FIG. 19 is a sectional view of a water passage body according to the first embodiment of the present invention.

FIG. 20 is a cross-sectional view of the glass rinser in an open state and schematic illustration of water flow therein according to a second embodiment of the present invention.

FIG. 21 is a cross-sectional view of the glass rinser in a closed state according to a second embodiment of the present invention.

FIG. 22 is a perspective view of partial components of the second embodiment of the present invention.

FIG. 23 shows yet another embodiment of configuring the first teeth and second teeth.

### DETAILED DESCRIPTION OF THE INVENTION

To further explain the technical solutions of the present invention, the present invention will be described in detail below with reference to specific embodiments.

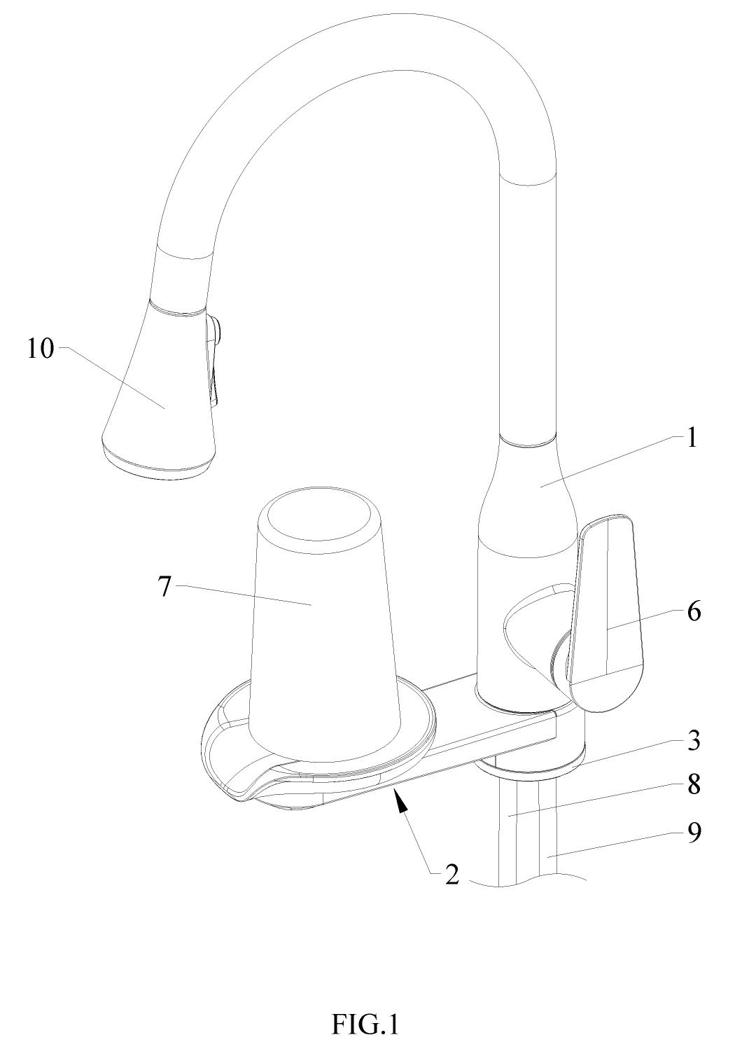

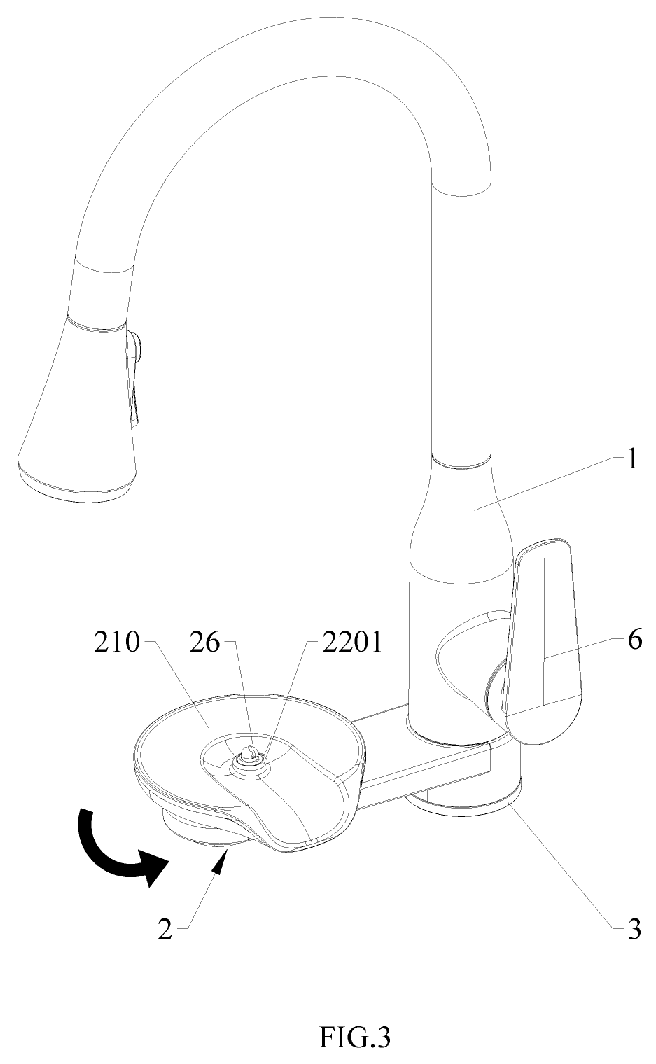

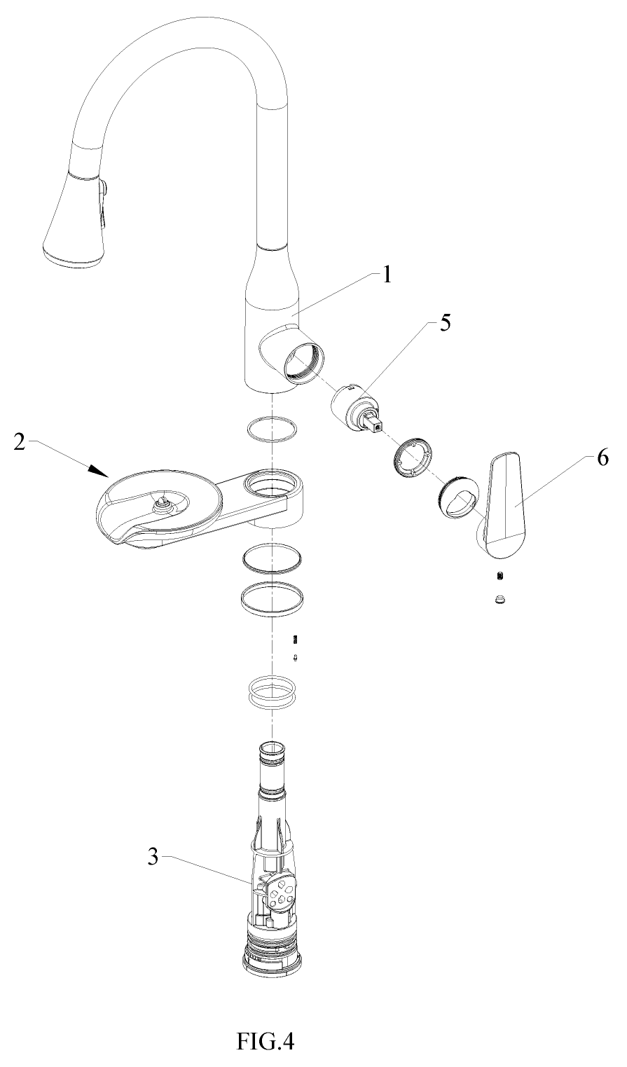

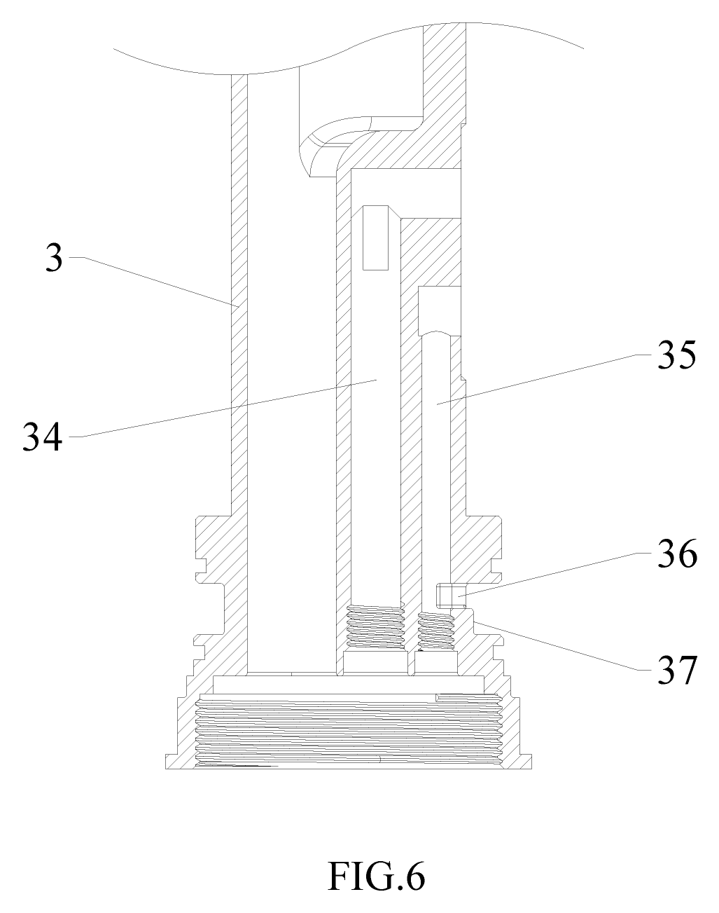

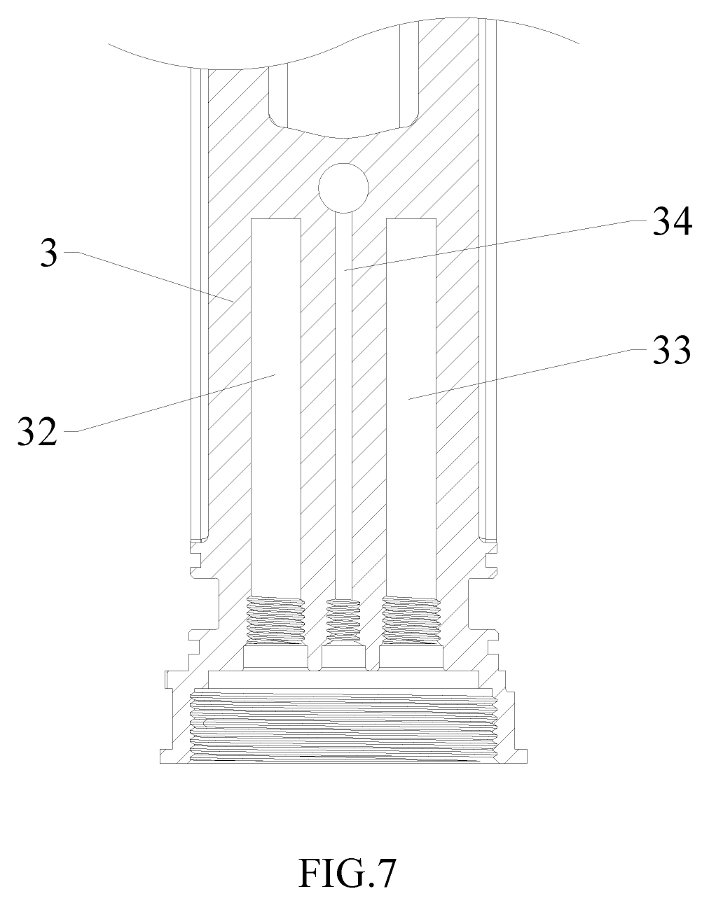

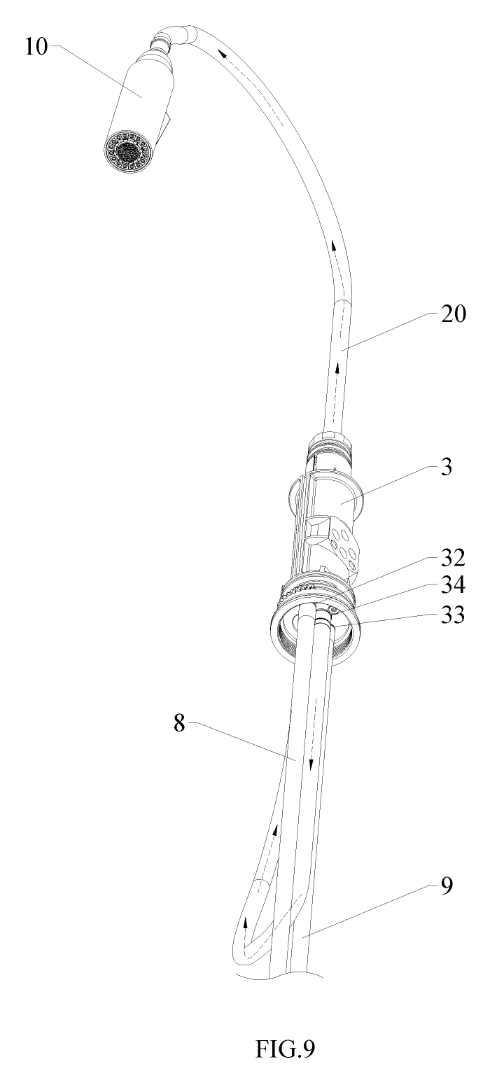

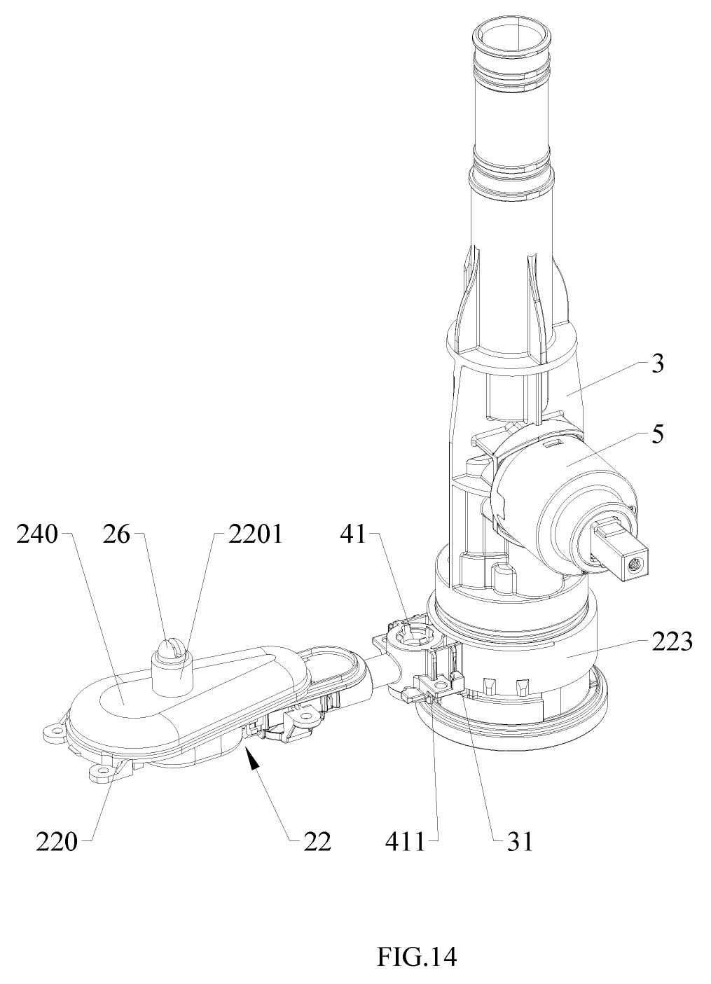

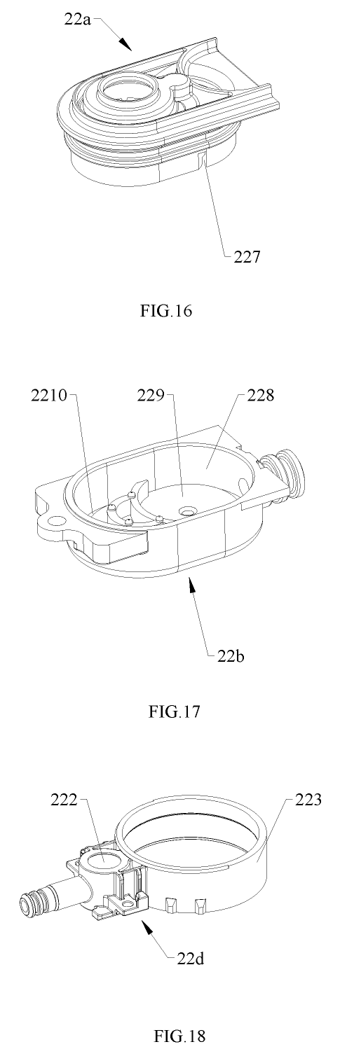

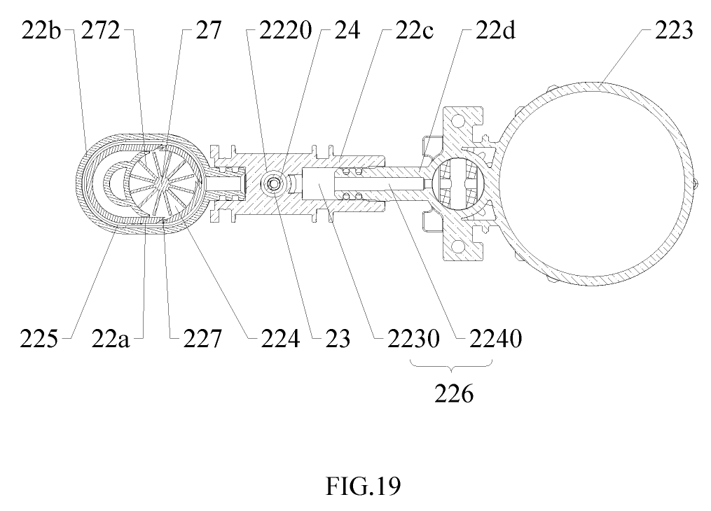

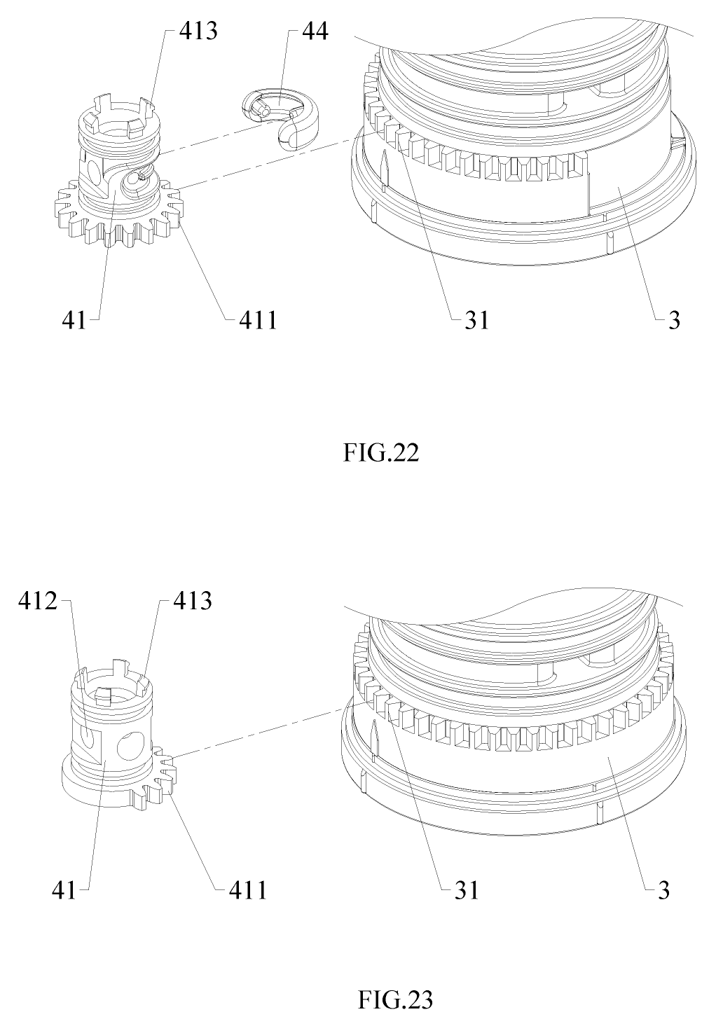

With reference to FIGS. 1-23, the present invention discloses a faucet with a glass rinser, comprising a faucet body 1, a glass rinser 2, a faucet base 3, and a valve core assembly 4;

the faucet base 3 is disposed inside the faucet body 1, and a circumferential surface of the faucet base 3 is at least partially provided with a plurality of first teeth 31;

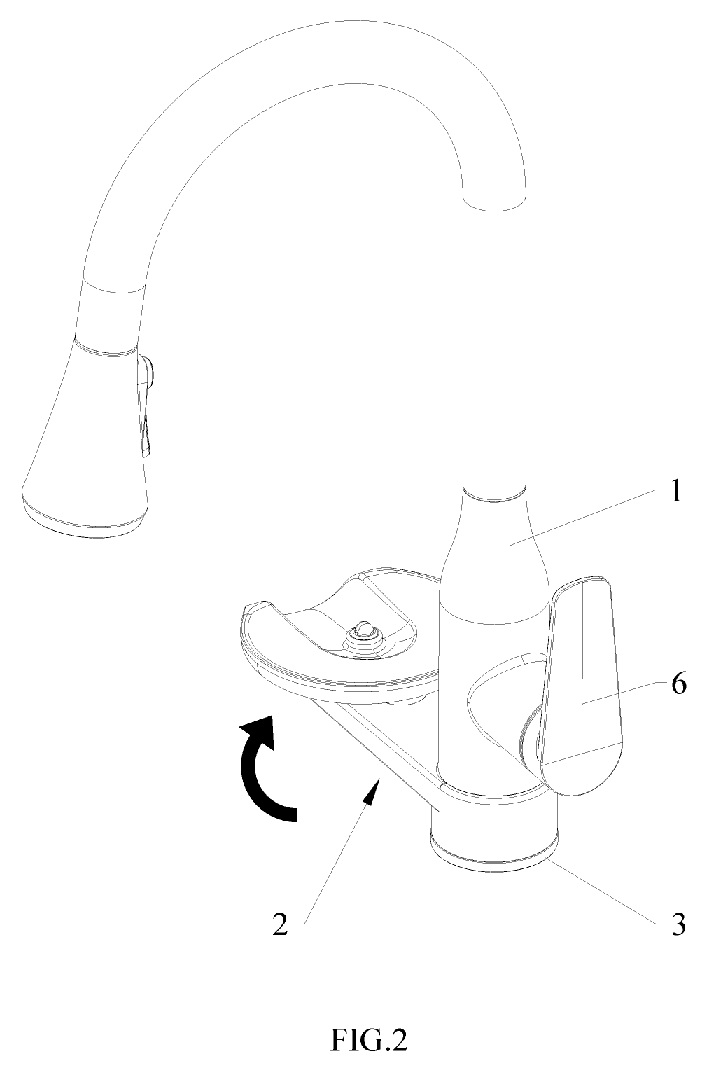

the glass rinser 2 is disposed on one side of the faucet body 1 and is rotatable about the faucet base 3 with the faucet base 3 being an axis of rotation (please refer to FIGS. 1 and 2); the glass rinser 2 is provided with a water passage 221 therein; the faucet base 3 supplies water to the water passage 221; a mounting hole 222 in communication with the water passage 221 is provided on the glass rinser 2 at a position between two ends of the glass rinser 2;

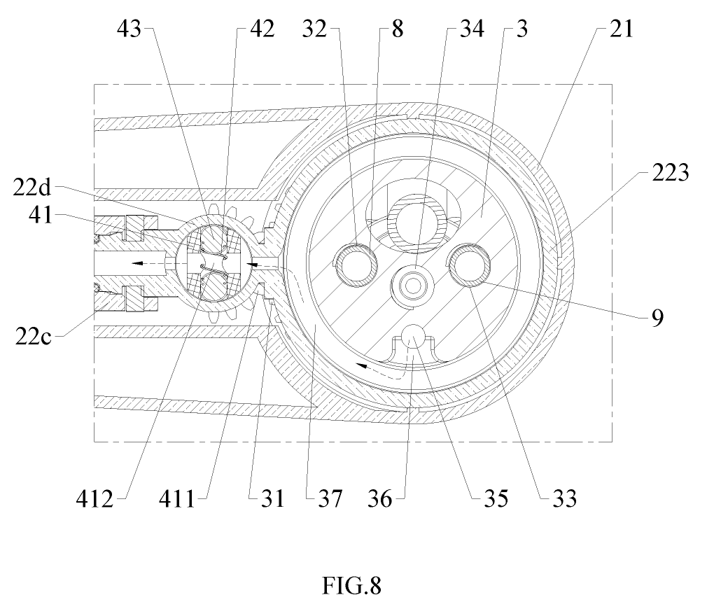

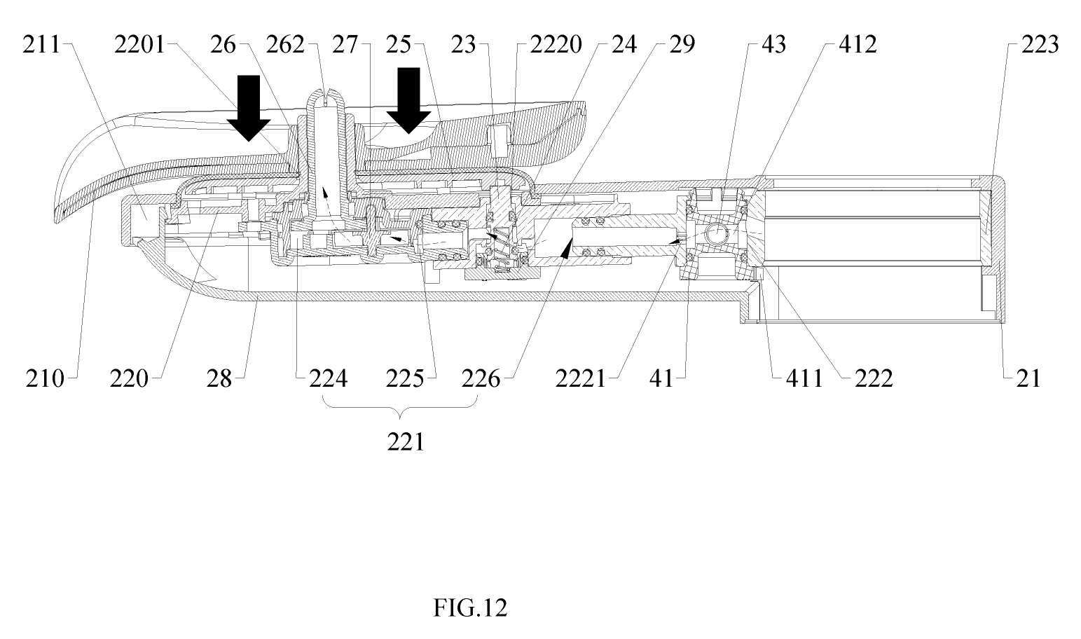

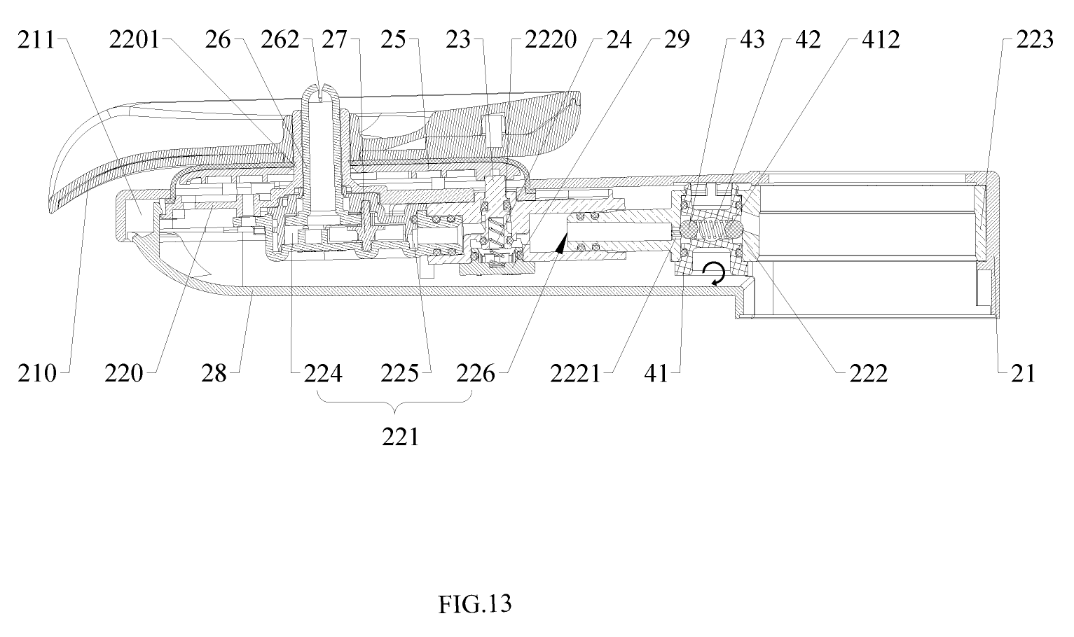

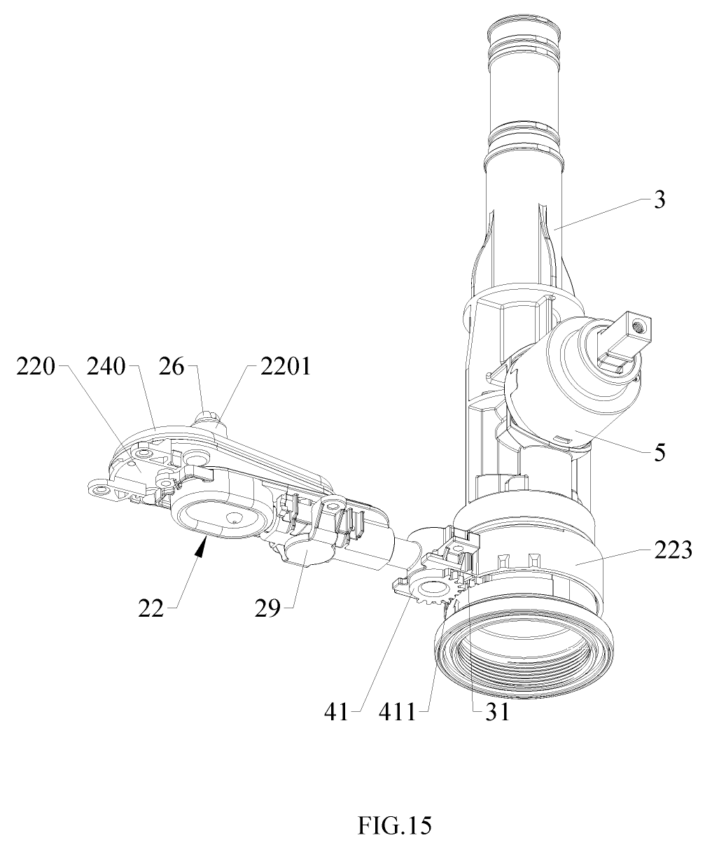

the valve core assembly 4 is rotatably mounted within the mounting hole 222; the valve core assembly 4 is sealed against the mounting hole 222 and always remains sealed against the mounting hole 222 even during rotation; the valve core assembly 4 controls connection and disconnection between two ends of the water passage 221 (please refer to FIGS. 12 and 13); an end of the valve core assembly 4 exposed from the mounting hole 222 is provided with a plurality of second teeth 411 at least partially on a circumferential surface thereof; the plurality of second teeth 411 mesh with the plurality of first teeth 31 (please refer to FIGS. 8 and 15).

According to the above technical solutions, the glass rinser 2 of the present invention can rotate about the faucet base 3 with the faucet base 3 being an axis of rotation, thereby allowing the glass rinser to rotate left and right to avoid interference with the faucet body 1. When the glass rinser 2 is rotated to a position substantially parallel to an edge of the sink, it is less likely to be inadvertently actuated. Furthermore, mutually meshed first teeth 31 and second teeth 411 enable a linkage movement with the valve core assembly 4 inside the glass rinser 2, such that when the glass rinser 2 is rotated, the valve core assembly 4 is also driven to control connection and disconnection between the two ends of the water passage 221. When the valve core assembly 4 is in an open state, the faucet base 3 can supply water to the glass rinser 2; when the valve core assembly 4 is in a closed state, the faucet base 3 cannot supply water to the glass rinser 2. User can enable and disable water inlet of the glass rinser 2 by rotating the glass rinser 2 left and right. In the closed state of the valve core assembly 4, the user is prevented from being wet by high-pressure water due to inadvertently actuation of a button 25 of the glass rinser 2.

With reference to FIGS. 1-18, a first embodiment of the present invention is shown and described in detail below.

In a preferred embodiment, either the first teeth 31 or the second teeth 411, or both the first teeth 31 and the second teeth 411 are distributed partially around the respective circumferential surface of the faucet valve body 3 and/or the valve core assembly 4. In other words, the first teeth 31 and/or the second teeth 411 are not annular in shape. This allows the second teeth 411 to disengage from the first teeth 31 after the glass rinser 2 is rotated past a certain angle, and as a result, the valve core assembly 4 will maintain its current state (open or closed state) and will not change, until the glass rinser 2 is rotated oppositely past a certain angle such that the second teeth 411 engage with the first teeth 31 again. In the first embodiment of the present invention, both the first teeth 31 and the second teeth 411 are distributed partially around the circumferential surface of the faucet valve body 3 and the circumferential surface of the valve core assembly 4.

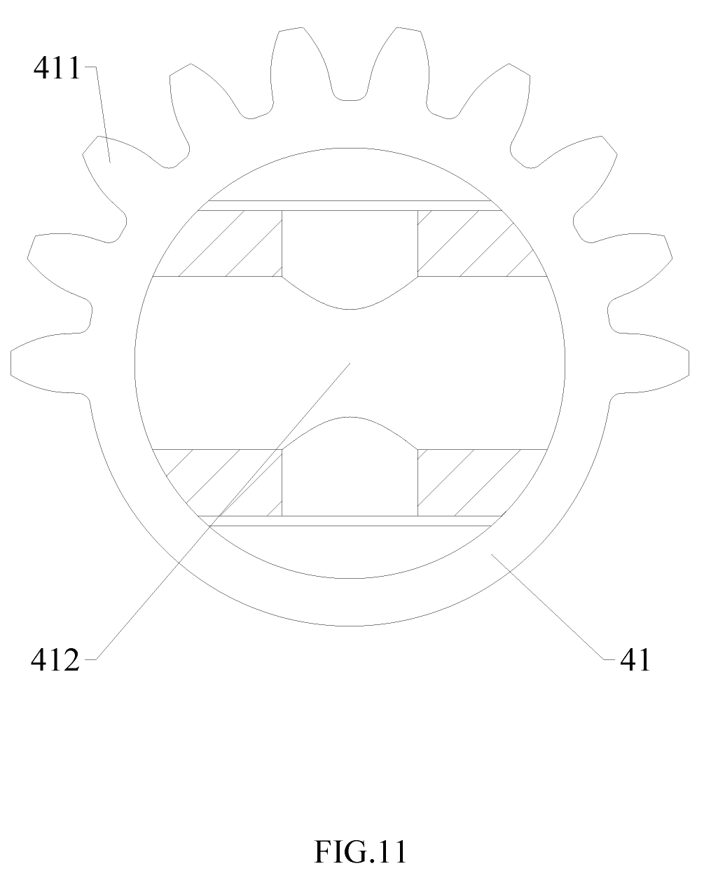

The valve core assembly 4 is a sealed ball valve, which comprises a rotatable shaft 41, a biasing spring 42, and two sealing balls 43. With reference to FIGS. 11-13, a circumferential surface of one end of the rotatable shaft 41 is at least partially provided with the second teeth 411, and a portion of the rotatable shaft 41 above said one end of the rotatable shaft 41 provided with the second teeth 411 is sealed against the mounting hole 222 and remains sealed against the mounting hole 222 even when the rotatable shaft 41 rotates; the rotatable shaft 41 is also provided with a cross-shaped hole 412 that penetrates through a circumferential surface of the rotatable shaft 41; the biasing spring 42 is disposed inside the cross-shaped hole 412, and two ends of the biasing spring 42 are disposed with the two sealing balls 43 respectively. Thus, the valve core assembly 4 uses the two sealing balls 43 to open or close a communication hole 2221 between the water passage 221 and the mounting hole 222 under the elastic force of the biasing spring 42, thereby achieving connection and disconnection between the two ends of the water passage 221 (please refer toe FIGS. 12 and 13). Specifically, when the rotatable shaft 41 rotates to a position where the sealing balls 43 align with the communication hole 2221, one of the sealing balls 43 is pushed out by the biasing spring 42 to block the communication hole 2221. When the sealing balls 43 are misaligned with the communication hole 2221, the sealing balls 43 are pushed back into the cross-shaped hole 412 by an inner circumferential wall of the mounting hole 222, and the biasing spring 42 is thus being compressed.

Further, another end of the rotatable shaft 41 is provided with a plurality of clasps 413; the plurality of clasps 413 hook onto an opening of the mounting hole 222 to achieve relative fixation between the rotatable shaft 41 and the glass rinser 2. The two sealing balls 43 can be made of rubber, ensuring a sealing and leak-proof effect through their elasticity.

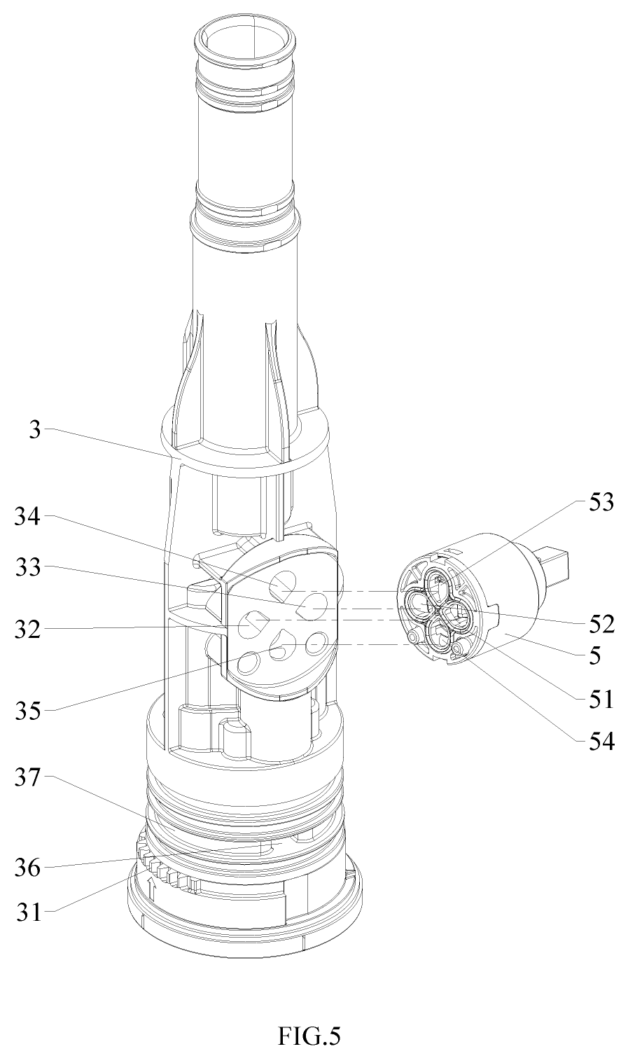

The present invention also comprises a water distribution faucet 5 disposed inside the faucet body 1 and connected with the faucet base 3; the faucet base 3 is provided with a first water inlet path 32, a second water inlet path 33, a first water outlet path 34, and a second water outlet path 35, all of which being in communication with the water distribution faucet 5 at a surface of the faucet base 3 connecting with the water distribution faucet 5. Input ends of the first water inlet path 32 and the second water inlet path 33 are configured to be connected to a cold water pipe 8 and a hot water pipe 9 respectively. Output ends of the first water outlet path 34 and the second water outlet path 35 are connected to a water outlet end of the faucet (i.e. a water outlet spout of the faucet body, such as a sprayer 10 or an aerator) and the glass rinser 2 respectively (In other words, the output end of the second water outlet path 35 is connected and in communication with the water passage 221). With reference to FIG. 5, a surface of the water distribution faucet 5 connecting with the faucet base 3 has a first water inlet opening 51, a second water inlet opening 52, a first water outlet opening 53, and a second water outlet opening 54; the first water inlet opening 51 and the second water inlet opening 52 are connected to and in communication with output ends of the first water inlet path 32 and the second water inlet path 33 respectively; the first water outlet opening 53 and the second water outlet opening 54 are connected to and in communication with input ends of the first water outlet path 34 and the second water outlet path 35 respectively. Specifically, the first water outlet path 34 is in communication with the sprayer 10 through a draw tube 20; the draw tube extends vertically passing through the faucet base 3; the output end of the second outlet water path 35 is in communication with the glass rinser 2 through a third water outlet 36 (as will be described below), a water channel 37 (as will be described below), and an inner wall of the annular sealing part 223 (as will be described below). When the water distribution faucet 5 is driven by a handle 6, the water distribution faucet 5 allows water to flow out from one of the first water inlet path 32 and the second water inlet path 33 to one of the first water outlet path 34 and the second water outlet path 35, or allows water from the first water inlet path 32 and the second water inlet path 33 to be adjustably mixed according to a predetermined proportion to obtain mixed water which then flows to one of the first water outlet path 34 and the second water outlet path 35, or disallow the first water inlet path 32 and the second water inlet path 33 to communicate with the first water outlet path 34 and the second water outlet path 35 so as to shut off water outlet. The specific structures of the water distribution faucet 5 have been disclosed in the same applicant's granted utility model CN221003880U and so the structures of the water distribution faucet 5 are published and known in the relevant field of art, and therefore will not be elaborated herein. Thus, the present invention utilizes a water distribution faucet 5 with dual inlets and dual outlets from the prior art and modifies the structures of the faucet base 3 to supply both cold and/or hot water to the water outlet end of the faucet and also provide an additional water path to supply water to the glass rinser 2. Accordingly, the glass rinser 2 attached to the faucet is no longer mono-functional due to the additional abilities to adjust water temperature and water flow rate, thereby allowing the glass rinser 2 to have broader scope of applications to meet diversified user’s needs.

Further, with reference to FIGS. 5-8, one side of the faucet base 3 is provided with a third water outlet 36 which is the output end of the second water outlet path 35. An input end of the glass rinser 2 is in communication with the third water outlet 36.

Furthermore, the circumferential surface of the faucet base 3 is recessed to form a water channel 37. The water channel 37 is located adjacent to the first teeth 31 along an axial direction of the faucet base 3. The third water outlet 36 is disposed in the water channel 37 to allow the water channel 37 to communicate with the second water outlet path 35. The input end of the glass rinser 2 is provided with an annular sealing part 223. An inner wall of the annular sealing part 223 is in communication with the mounting hole 222, and the annular sealing part 223 is rotatably mounted around the circumferential surface of the faucet base 3, covering the water channel 37. The annular sealing part 223 is sealed against the circumferential surface of the faucet base 3 and remains sealed against the circumferential surface of the faucet base 3 even when the annular sealing part 223 rotates. Thus, the water channel 37 is also always sealed by the annular sealing part 223. As such, a waterway is formed between the faucet base 3 and the annular sealing part 223 to put the second water outlet path 35 and the third water outlet 36 into communication with each other, such that the faucet base 3 is eventually in communication with the water passage 221. The valve core assembly 4 inside the mounting hole 222 can control communication between the faucet base 3 and the water passage 221. By first configuring the water channel 37 on the circumferential surface of the faucet base 3 and then enclosing and sealing the water channel 37 with the annular sealing part 223 to form a waterway, the second water outlet path 35 and the third water outlet 36 are designed to be more easily in communication with each other.

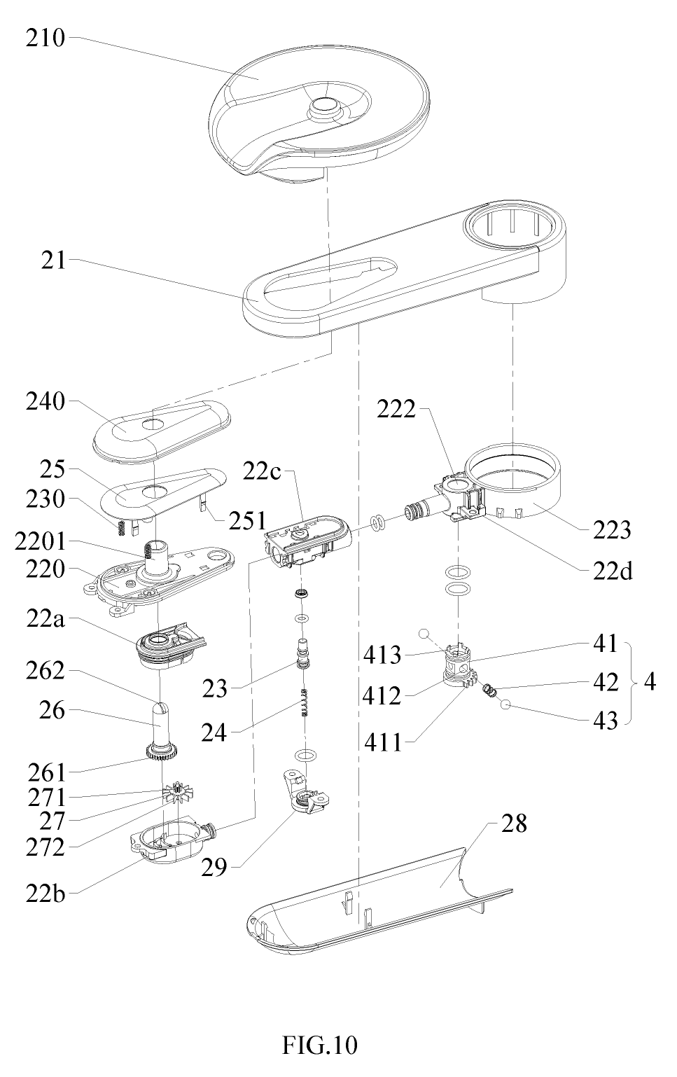

With reference to FIGS. 10-19, the present invention also modifies the structures of the glass rinser 2 to provide a rotating spray cleaning function. Specifically, the glass rinser 2 comprises a support platform 21 disposed on said one side of the faucet body 1, a water passage body 22 disposed within the support platform 21, a piston rod 23 and a piston spring 24 disposed within the water passage body 22, a button 25 connected to the piston rod 23, a nozzle 26, and an impeller gear 27. The water passage body 22 is provided with an outlet chamber 224, an annular channel 225, and an inlet channel 226, which are sequentially connected to form the water passage 221. A circumferential surface of the outlet chamber 224 is provided with at least one inclined water hole 227. The annular channel 225 is arranged around the circumferential surface of the outlet chamber 224 and communicates with the outlet chamber 224 through said at least one inclined water hole 227. Two ends of the inlet channel 226 are connected to the annular channel 225 and the faucet base 3 respectively to receive water supply from the faucet base 3 located inside the faucet body 1. The piston rod 23, under resilient force of the piston spring 24, blocks communication between the two ends (input end and output end) of the inlet channel 226, thereby achieving opening and closing of the inlet channel 226. The button 25 is movably fitted on an upper surface of the support platform 21. The impeller gear 27 is rotatably fitted in the outlet chamber 224 and is positioned facing towards said at least one inclined water hole 227. An outer end of the nozzle 26 is exposed from the upper surface of the support platform 21, and an inner end of the nozzle 26 is inserted into the passage body 22 and rotatably connected with the impeller gear 27 so that rotation of the impeller gear 27 will drive the nozzle 26 to rotate synchronously. A lower portion of the nozzle 26 is sealed against the passage body 22 and remains sealed against the passage body 22 even when the nozzle rotates. Thus, when the glass rinser 2 is used with the impeller gear 27 disposed in the water passage body 22, water flowing from the inlet channel 226 to the annular channel 225 forms an annular (circular) water flow in the annular channel 225, and the water will then enter the outlet chamber 224 through said at least one inclined water hole 227, driving the impeller gear 27 to rotate and thus driving the nozzle 26 to rotate synchronously. This ultimately achieves 360° rotating water spray, providing a more comprehensive cleaning of a cup 7 or other container. Compared to conventional glass rinsers, the rotating water spray offers a more comprehensive and efficient cleaning effect. Further, when the water distribution faucet 5 allows the first water inlet path 32 and/or the second water inlet path 33 to be in communication with the second water outlet path 35 (in this state, water will flow out from the second water outlet path 35 into the third water outlet 36 and the water channel 37), the button 25 of the glass rinser 2 is pressed down, and the valve core assembly 4 opens, the nozzle 26 will be able to eject water. However, if either the button 25 is not pressed down, or the valve core assembly 4 is closed, the nozzle 26 will stop ejecting water. Apparently, through the above description about the inter-relationship between the valve core assembly 4 and the faucet base 3, it is understood that after user finishes using the glass rinser 2, the glass rinser 2 can be rotated to an initial position to avoid interference with the sink, and as the glass rinser 2 is rotated to such position, the valve core assembly 4 will rotate to a closed state to shut down water supply to the glass rinser 2.

In the structural details of the glass rinser 2, a circumferential surface of the impeller gear 27 is provided with a first gear 271, and an inner end of the nozzle 26 is provided with a second gear 261 that meshes with the first gear 271. A diameter of the first gear 271 is smaller than a diameter of a blade portion 272 of the impeller gear 27 to form a difference in diameter to increase a turning moment of the impeller gear 27. A transmission ratio between the first gear 271 and the second gear 261 is at least 1:5 to increase a turning moment of the nozzle 26, enabling the nozzle 26 to overcome frictional force and rotate. The frictional force comes from a heterogeneous-shaped sealing ring provided around the circumferential surface of the nozzle 26 to enhance dynamic sealing effect of the lower portion of the nozzle 26 against the passage body 22.

In the structural details of the glass rinser 2, the outer end of the nozzle 26 is provided with an elongated water outlet 262 which is a flat and narrow slit in an I-shape. Thus, when the nozzle 26 is driven to rotate by the impeller gear 27, a jet of I-shaped water from the elongated water outlet 262 will dynamically rotate as the nozzle 26 rotates, so that said 360° rotating water spray is generated. The rotating water spray is more convenient for cleaning containers like cups, thereby improving cleaning efficiency.

In the structural details of the glass rinser 2, for the ease of component manufacturing and molding, the water passage body 22 comprises an upper cover 22a, a base 22b, a water passage member 22c, and a connecting member 22d independently constructed with respect to one another. The base 22b, the water passage member 22c, and the connecting member 22d are sequentially sealed, connected, and in communication with one another. The base 22b is provided with a groove 228, an inner bottom side of the base 22b is raised with a terrace 229. A periphery of the terrace 229 is provided with an annular groove 2210 adjacent to an inner side wall of the groove 228. The upper cover 22a is sealed and fitted on the inner side wall of the groove 228, such that the outlet chamber 224 is formed between the upper cover 22a and the terrace 229, and the annular channel 225 is formed between the upper cover 22a and the annular groove 2210. Said at least one inclined water hole 227 is provided on a circumferential surface of the upper cover 22a. A first communication channel 2230 of the water passage member 22c and a second communication channel 2240 of the connecting member 22d together define said inlet channel 226. The piston rod 23 is installed in the water passage member 22c, specifically in an installation hole 2220 of the water passage member 22c located vertically passing through the water passage member 22c. Thus, during production, only a groove structure (i.e. annular groove 2210) needs to be formed on the base 22b, and said groove structure, when sealed with the upper cover 22a during assembly, define the outlet chamber 224. This simplifies component molding and facilitates demolding. Furthermore, in the above description, since the water passage body 22 and the annular sealing part 223 can rotate synchronously around the faucet base 3, they can be either detachably connected or integrally formed. Specifically, in the present embodiment, the connecting member 22d and the annular sealing part 223 can be directly and integrally formed as one piece, allowing one end of the connecting member 22d to be fitted onto the circumferential surface of the faucet base 3. This reduces the number of components during production and thus simplifies assembly.

In the structural details of the glass rinser 2, a bottom surface of the support platform 21 is recessed to form a mounting groove 211; the water passage body 22 is installed in the mounting groove 211. An opening of the mounting groove 211 is fitted with a bottom cover 28 to conceal the water passage body 22. The bottom cover 28 is connected to the water passage body 22 by buckling. This ensures an aesthetic appearance and allows for quick removal of the water passage body 22 from the support platform 21 without having to detach the support platform 21 from the faucet.

Further, the glass rinser 2 also comprises a retaining plate 29. An installation hole 2220 is provided on the water passage body 22 vertically passing through the water passage body 22; the installation hole 2220 penetrates through the water passage body 22. The piston rod 23 is movably mounted within the installation hole 2220; the piston rod 23 is sealed and always remains sealed against the installation hole 220 even when the piston rod 23 moves; an upper end of the piston rod 23 passes through the installation hole 2220 and connects with the button 25. The retaining plate 29 is disposed at a bottom end of the installation hole 2220 and seals the bottom end of the installation hole 2220. Two sides of the retaining plate 29 are connected to the mounting groove 211, such as by screws. Thus, the retaining plate 29 not only fixes and secures the water passage body 22 within the support platform 21 but also seals the installation hole 2220. The retaining plate 29 also facilitates removal and replacement, and also cleaning of the piston rod 23 when being removed.

In the structural details of the glass rinser 2, the glass rinser 2 also comprises a drip tray 210 and a rotating base 220. The rotating base 220 is fixed to an upper surface of the water passage body 22, such as by screws, and is provided with a shaft tube 2201 through which the nozzle 26 passes through. A lengthwise direction of the rotating base 220 is consistent with a lengthwise direction of the glass rinser 2, i.e., extending radially from the faucet body 1. The button 25 has a shape that corresponds to a shape of the rotating base 220; the button 25 is movably fitted with and positioned above the rotating base 220 by elongated fasteners 251 on two sides thereof, thereby preventing the button 25 from being detached from the rotating base 220. The piston rod 23 is disposed below one end of the button 25, and a reset spring 230 is disposed between another end of the button 25 and the rotating base 220. The shaft tube 2201 passes through the button 25. The drip tray 210 is rotatably fitted around the shaft tube 2201. The nozzle 26 extends upward to form a column that passes through the shaft tube 2201. The detachable drip tray 210 (which can be directly removed from the shaft tube 2201) can be optionally used by users according to their own needs to prevent water from splashing during cleaning by directing the water into the sink using the drip tray 210. Furthermore, in the prior art, the pressing shaft of a glass rinser (corresponding to the piston rod 23 of the present invention) that actuates rinsing is typically arranged around an area adjacent to the nozzle, but this configuration requires a larger space underneath the nozzle (i.e., inside the glass rinser), making it difficult to obtain a thin glass rinser. A thick glass rinser can take up vertical space, leading to interference ("clashing") with the water outlet end of the faucet when cleaning taller glasses. By contrast, the present invention provides an elongated button 25 that increases the surface area of the button 25 relative to the drip tray 210, allowing the user to apply force to the button 25 by pressing anywhere of the drip tray 210, thereby opening a water path via the piston rod 23. The present invention no longer limits operation at the area immediately adjacent the nozzle 26, so that operation is more convenient and the user’s experience is therefore improved. Additionally, the elongated button 25 allows for a certain distance between the piston rod 23 and the nozzle 26, so that a center of the drip tray 210 (i.e., where the nozzle 26 is located) can avoid the water outlet end of the faucet, thereby preventing potential interference with the water outlet end of the faucet during glass washing.

Further, an elastic diaphragm 240 is disposed between the rotating base 220 and the support platform 21. A periphery of the elastic diaphragm 240 is clamped by the support platform 21 and the rotating base 220; the elastic diaphragm 240 also covers an upper surface of the button 25. The elastic diaphragm 240 can deform when the drip tray 210 and the button 25 are pressed.

In the above description, all positions among the components of the present invention that require sealing, no matter if it is dynamic sealing or static sealing, to prevent water leakage, can be sealed using O-rings or heterogeneous-shaped sealing rings.

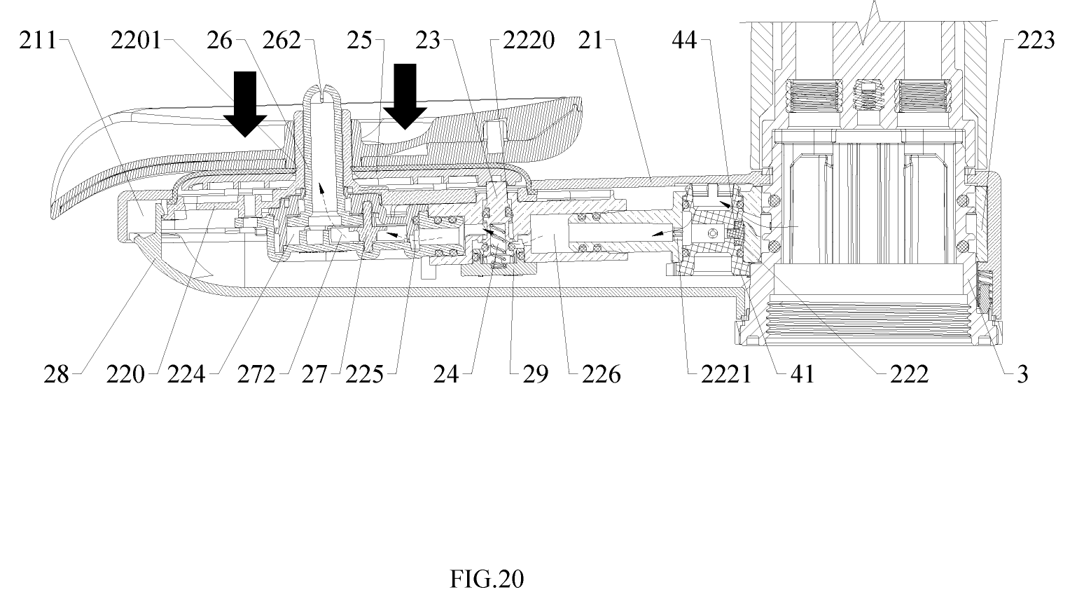

With reference to FIGS. 20-22, a second embodiment of the present invention is shown. Most of the structural details of the second embodiment are the same or similar to that of the first embodiment. The differences are as follows:

The first teeth 31 extend around the circumferential surface of the faucet base 3 by half a length of the circumferential surface of the faucet base 3 and thus being semi-circular around the circumferential surface of the faucet base 3. i.e., the first teeth 31 occupy 180° of the circumferential surface of the faucet base 3. The second teeth 411 are completely annular around the circumferential surface of the valve core assembly 4. According to this structural design, gear meshing always exists between the faucet base 3 and the valve core assembly 4. In other words, regardless of how much the glass rinser 2 rotates, the first teeth 31 always mesh with the second teeth 411, thereby preventing tooth misalignment and the resulting accelerated wearing of the teeth.

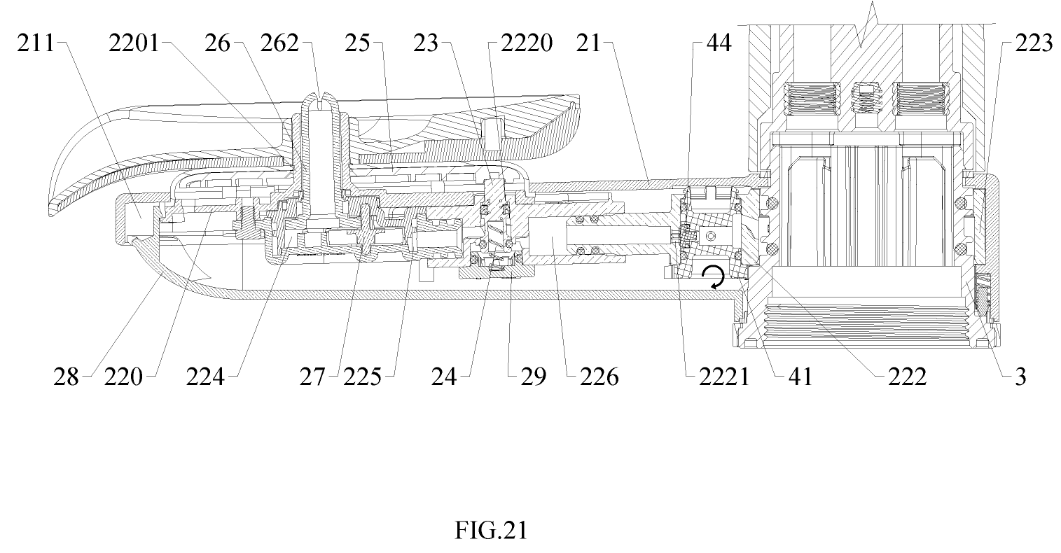

In the second embodiment, the valve core assembly 4 no longer comprises the biasing spring 42 and the two sealing balls 43, but instead comprises the rotatable shaft 41 and a U-shaped cup seal 44. A circumferential surface of one end of the rotatable shaft 41 is provided with the second teeth 411, and a portion of the rotatable shaft 41 above said one end of the rotatable shaft 41 provided with the second teeth 411 is sealed against the mounting hole 222 and remains sealed even when the rotatable shaft 41 rotates. The U-shaped cup seal 44 is installed on the circumferential surface of the rotatable shaft 41; when the rotatable shaft 41 rotates, the U-shaped cup seal 44 opens or closes the communication hole 2221 between the water passage 221 and the mounting hole 222, thereby achieving connection and disconnection between the two ends of the water passage 221 (please refer to FIGS. 20 and 21). Compared to the solution with the biasing spring 42 and the two sealing balls 43, the U-shaped cup seal 44 has a simpler structure and provides a surface seal against the communication hole 2221, without direct contact with the edge of the communication hole 2221, thereby resulting in less wearing and a lower likelihood of failure.

Further, as shown in FIG. 23, in still another embodiment, it is possible that the first teeth 31 extend around the entire circumferential surface of the faucet base 3, while the second teeth 411 extend around the circumferential surface of the valve core assembly 4 by half a length of the circumferential surface of the valve core assembly 4 and thus being semi-circular around the circumferential surface of the valve core assembly 4 (i.e. 180° of the circumferential surface of the valve core assembly 4).

The above-described embodiments and drawings are not intended to limit the form and style of the present invention. Any appropriate changes or modifications made by a person of ordinary skill in the art should be considered as not departing from the scope of the present invention.

1. A faucet, comprising a faucet body, a glass rinser, a faucet base, and a valve core assembly;
the faucet base is disposed inside the faucet body, and a circumferential surface of the faucet base is at least partially provided with a plurality of first teeth;
the glass rinser is disposed on one side of the faucet body and is rotatable about the faucet base with the faucet base being an axis of rotation; the glass rinser is provided with a water passage therein; the faucet base supplies water to the water passage; a mounting hole in communication with the water passage is provided on the glass rinser at a position between two ends of the glass rinser;
the valve core assembly is rotatably mounted within the mounting hole; the valve core assembly is sealed against the mounting hole always remains sealed against the mounting hole even when the valve core assembly rotates;
an end of the valve core assembly exposed from the mounting hole is provided with a plurality of second teeth at least partially on a circumferential surface thereof; the plurality of second teeth mesh with the plurality of first teeth.

2. The faucet of claim 1, wherein either the plurality of first teeth or the plurality of second teeth, or both the plurality of first teeth and the plurality of second teeth are distributed partially around a respective circumferential surface of the faucet valve body and/or a respective circumferential surface of the valve core assembly.

3. The faucet of claim 1, wherein the plurality of first teeth extend around the circumferential surface of the faucet base by half a length of the circumferential surface of the faucet base and thus being semi-circular around the circumferential surface of the faucet base; the plurality of second teeth are completely annular around the circumferential surface of the valve core assembly.

4. The faucet of claim 1, wherein the valve core assembly comprises a rotatable shaft, a biasing spring, and two sealing balls; a circumferential surface of one end of the rotatable shaft is at least partially provided with the plurality of second teeth, and a portion of the rotatable shaft above said one end of the rotatable shaft provided with the plurality of second teeth is sealed against the mounting hole and remains sealed against the mounting hole even when the rotatable shaft rotates; the rotatable shaft is also provided with a cross-shaped hole that penetrates through a circumferential surface of the rotatable shaft; the biasing spring is disposed inside the cross-shaped hole, and two ends of the biasing spring are disposed with the two sealing balls respectively.

5. The faucet of claim 1, wherein the valve core assembly comprises a rotatable shaft and a U-shaped cup seal; a circumferential surface of one end of the rotatable shaft is provided with the plurality of second teeth, and a portion of the rotatable shaft above said one end of the rotatable shaft provided with the plurality of second teeth is sealed against the mounting hole and remains sealed against the mounting hole even when the rotatable shaft rotates; the U-shaped cup seal is installed on the circumferential surface of the rotatable shaft; when the rotatable shaft rotates, the U-shaped cup seal opens or closes the communication hole between the water passage and the mounting hole.

6. The faucet of claim 1, also comprising a water distribution faucet disposed inside the faucet body and connected with the faucet base; the faucet base is provided with a first water inlet path, a second water inlet path, a first water outlet path, and a second water outlet path, all of which being in communication with the water distribution faucet at a surface of the faucet base connecting with the water distribution faucet; input ends of the first water inlet path and the second water inlet path are connected to a cold water pipe and a hot water pipe respectively; output ends of the first water outlet path and the second water outlet path are connected to a water outlet end of the faucet and the glass rinser respectively; a surface of the water distribution faucet connecting with the faucet base has a first water inlet opening, a second water inlet opening, a first water outlet opening, and a second water outlet opening; the first water inlet opening and the second water inlet opening are connected to and in communication with output ends of the first water inlet path and the second water inlet path respectively; the first water outlet opening and the second water outlet opening are connected to and in communication with input ends of the first water outlet path and the second water outlet path respectively.

7. The faucet of claim 6, wherein one side of the faucet base is provided with a third water outlet which is the output end of the second water outlet path; an input end of the glass rinser is in communication with the third water outlet.

8. The faucet of claim 7, wherein the circumferential surface of the faucet base is also recessed to form a water channel; the third water outlet is disposed in the water channel; the input end of the glass rinser is provided with an annular sealing part; an inner wall of the annular sealing part is in communication with the mounting hole, and the annular sealing part is mounted around the circumferential surface of the faucet base, covering the water channel.

9. The faucet of claim 1, wherein the glass rinser comprises a support platform disposed on said one side of the faucet body, a water passage body disposed within the support platform, a piston rod and a piston spring disposed within the water passage body, a button connected to the piston rod, a nozzle, and an impeller gear; the water passage body is provided with an outlet chamber, an annular channel, and an inlet channel, which are sequentially connected to form the water passage; a circumferential surface of the outlet chamber is provided with at least one inclined water hole; the annular channel is arranged around the circumferential surface of the outlet chamber and communicates with the outlet chamber through said at least one inclined water hole; two ends of the inlet channel are connected to the annular channel and the faucet base respectively; the piston rod, under resilient force of the piston spring, blocks communication between an input end and an output end of the inlet channel; the button is movably fitted on an upper surface of the support platform; the impeller gear is rotatably fitted in the outlet chamber and is positioned facing to said at least one inclined water hole; an outer end of the nozzle is exposed from the upper surface of the support platform, and an inner end of the nozzle is inserted into the passage body and rotatably connected with the impeller gear so that rotation of the impeller gear drives the nozzle to rotate synchronously; a lower portion of the nozzle is sealed against the passage body and remains sealed against the passage body even when the nozzle rotates.

10. The faucet of claim 9, wherein a circumferential surface of the impeller gear is provided with a first gear, and the inner end of the nozzle is provided with a second gear that meshes with the first gear; a diameter of the first gear is smaller than a diameter of a blade portion of the impeller gear; a transmission ratio between the first gear and the second gear is at least 1:5.

11. The faucet of claim 9, wherein the outer end of the nozzle is provided with an elongated water outlet which is a flat and narrow slit.

12. The faucet of claim 9, wherein the water passage body comprises an upper cover, a base, a water passage member, and a connecting member independently constructed with respect to one another; the base, the water passage member, and the connecting member are sequentially sealed, connected, and in communication with one another; the base is provided with a groove; an inner bottom side of the base is raised with a terrace; a periphery of the terrace is provided with an annular groove adjacent to an inner side wall of the groove; the upper cover is sealed and fitted on the inner side wall of the groove, such that the outlet chamber is formed between the upper cover and the terrace, and the annular channel is formed between the upper cover and the annular groove; said at least one inclined water hole is provided on a circumferential surface of the upper cover; communication channels between the water passage member and the connecting member together define said inlet channel; the piston rod is installed in the water passage member.

13. The faucet of claim 9, wherein a bottom surface of the support platform is recessed to form a mounting groove; the water passage body is installed in the mounting groove; an opening of the mounting groove is fitted with a bottom cover to conceal the water passage body; the bottom cover is connected to the water passage body by buckling.

14. The faucet of claim 13, wherein the glass rinser also comprises a retaining plate; an installation hole is provided on the water passage body vertically passing through the water passage body; the installation hole penetrates through the water passage body; the piston rod is movably mounted within the installation hole; the piston rod is sealed and always remains sealed against the installation hole even when the piston rod moves; an upper end of the piston rod passes through the installation hole and connects with the button; the retaining plate is disposed at a bottom end of the installation hole and seals the bottom end of the installation hole; two sides of the retaining plate are removably connected to the mounting groove.

15. The faucet of claim 9, wherein the glass rinser also comprises a drip tray and a rotating base; the rotating base is fixed to an upper surface of the water passage body, and is provided with a shaft tube through which the nozzle passes through; the button is movably fitted with and positioned above the rotating base; the piston rod is disposed below one end of the button, and a reset spring is disposed between another end of the button and the rotating base; the shaft tube passes through the button; the drip tray is rotatably fitted around the shaft tube; the nozzle extends upward to form a column that passes through the shaft tube.

16. The faucet of claim 15, wherein an elastic diaphragm is disposed between the rotating base and the support platform; a periphery of the elastic diaphragm is clamped by the support platform and the rotating base; the elastic diaphragm also covers an upper surface of the button.
